(19) United States
(12) Patent Application Publication
(10) Pub. No.: US 2026/0254803 A1
(43) Pub. Date: Aug. 27, 2026

(54) METHODS, DEVICES, AND COMPUTER PROGRAMS FOR MANAGING A GROUP TEMPORAL KEY FOR PRIVACY BEACON

(71) Applicant: CANON KABUSHIKI KAISHA, Tokyo (JP)

(72) Inventors: Julien SEVIN, SAINT AUBIN DU CORMIER (FR); Stéphane BARON, LE RHEU (FR); Patrice NEZOU, LIFFRE (FR)

(21) Appl. No.: 19/550,055

(22) Filed: Feb. 25, 2026

(30) Foreign Application Priority Data
Feb. 27, 2025 (GB) 2502879.6

(51) Int. Cl. H04L 9/40

(52) U.S. Cl. CPC H04L 63/065

(57) ABSTRACT

At least an embodiment of a method in a communication network, the method comprising, at an access point, AP, affiliated with an AP multi-link device, MLD:
transmitting, to a non-AP station, STA, affiliated with a non-AP MLD, a management frame comprising a body field encrypted with a first group key; and
transmitting, to the STA, a frame including the first group key and a second group key, wherein the second group key is for encrypting data frames transmitted by the AP to the STA.

### PRIORITY CLAIM

This application claims the benefit under 35 U.S.C. § 119 (a)-(d) of United Kingdom Patent Application No. 2502879.6, filed on Feb. 27, 2025 and entitled “Methods, devices, and computer programs for managing a group temporal key for privacy beacon”. The above cited patent application is incorporated herein by reference in its entirety.

### FIELD OF THE DISCLOSURE

The present disclosure relates to wireless communications and more specifically to managing group keys among multi-link devices, for example for user privacy during wireless communications.

### BACKGROUND OF DISCLOSURE

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The IEEE 802.11 family of standards adopted by the Institute of Electrical and Electronics Engineers (IEEE-RTM) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

Personally Identifiable Information (PII) corresponds to any data that identify an individual or from which identity or contact information of an individual can be derived. A device's Media Access Control (MAC) address is an example of PII.

A dedicated task group IEEE 802.11bi has been initiated in 2019 to address those privacy concerns. Its objective is to specify Enhanced Data Privacy (EDP) features to be added in the current standard to increase privacy.

A set of EDP features referred to as Basic Service Set (BSS) Privacy Enhancement (BPE) features allows to protect privacy of Access-Point (AP) Multi-Link Devices (MLDs) and associated non-AP MLDs. An AP MLD supporting such BPE features is referred to as a BPE AP MLD and a non-AP MLD supporting such BPE features is referred to as a BPE non-AP MLD.

One of the BPE feature is the transmission of Privacy Beacon by the BPE AP MLD which allows not sending in clear BPE AP MLD discovery information (e.g., Service Set Identifier (SSID), capability or operation elements) in clear over the air. The header of a Privacy Beacon is anonymized according to a BPE frame anonymization procedure and its payload is encrypted with its Group Temporal Key (GTK) which is originally used to protect information exchanged in group addressed Data frames.

### SUMMARY OF THE DISCLOSURE

While the procedures described above are proving effective, there is a constant need to improve the security of exchanged data, in particular to protect personal data.

The present disclosure has been devised to address one or more of the foregoing concerns.

According to a first aspect of the disclosure, it is provided a method in a communication network, the method comprising, at an access point, AP, affiliated with an AP multi-link device, MLD:
transmitting, to a non-AP station, STA, affiliated with a non-AP MLD, a management frame comprising a body field encrypted with a first group key; and
transmitting, to the STA, a frame including the first group key and a second group key, wherein the second group key is for encrypting data frames transmitted by the AP to the STA.

Accordingly, the method of the disclosure makes it possible to improve security and privacy by applying a separation principle according to which each cryptographic key is used for a single and specific purpose.

According to some particular embodiments, the management frame is a beacon frame.

Still according to some particular embodiments, the beacon frame is a privacy beacon frame.

Still according to some particular embodiments, the body field comprises a Basic Service Set, BSS, Parameter Change Count, BPCC, a Traffic Indication Map, TIM, a

Reduced Neighbor Report, and/or an Extended Channel.

Still according to some particular embodiments, the first group key is generated by the non-AP MLD and shared among all APs affiliated with the non-AP MLD.

Still according to some particular embodiments, several APs, comprising the AP, are affiliated with the non-AP MLD, each of the several APs generating its own first group key, all the generated first group keys being transmitted to the STA in the frame including the first group key and a second group key in a MLO element.

Still according to some particular embodiments, a same cipher suite is used in relation to the first and the second group key to encrypt the data frame and the body field of the management frame.

Still according to some particular embodiments, the first group key and the second group key are transmitted in a Key Delivery element included in a (Re) Association Response frame during an association procedure.

Still according to some particular embodiments, the first group key and the second group key are updated and transmitted during a group key handshake.

Still according to some particular embodiments, the group key handshake is carried out upon determining sleep mode exit of the non-AP MLD.

Still according to some particular embodiments, the method further comprises creating a privacy security association in a robust security network association, RSNA, between the AP MLD and the STA, the first group key and the second group key being stored in the AP MLD, in the privacy security association.

Still according to some particular embodiments, the privacy security association is created upon determining a successful group key handshake, reassociation response frame of a fast basic service set, BSS, transition protocol, or successful fast initial link setup, FILS, or authentication.

Still according to some particular embodiments, the method further comprises deleting the privacy security association storing the first group key and the second group key upon determining that the AP MLD is in an independent basic service set, IBSS, or upon determining an association, reassociation or dissociation procedure of the non-AP MLD.

Still according to some particular embodiments, the first group key and the second group key are transmitted to the STA as wrapped keys with key identifiers in a frame subelement.

Still according to some particular embodiments, the first group key is a privacy management group temporal key, PMGTK, which value is a random number.

Still according to some particular embodiments, the method further comprises deleting the first group key upon determining dissociation of the STA.

According to a second aspect of the disclosure, it is provided a method in a communication network, the method comprising, at a non access-point, AP, station, STA, affiliated with a non-AP multi-link device, MLD:
receiving, from an AP affiliated with an AP MLD, a management frame comprising a body field encrypted with a first group key; and
receiving, from the AP, a frame including the first group key and a second group key, wherein the second group key is for decrypting data frames received from the AP.

Accordingly, the method of the disclosure makes it possible to improve security and privacy by applying a separation principle according to which each cryptographic key is used for a single and specific purpose.

Still according to some particular embodiments, the management frame is a beacon frame.

Still according to some particular embodiments, the beacon frame is a privacy beacon frame.

Still according to some particular embodiments, the method further comprises associating or reassociating the STA with the AP using elements of the body field of the beacon frame.

Still according to some particular embodiments, the first group key and the second group key are obtained in a Key Delivery element included in a (Re) Association Response frame during an association procedure mechanism.

Still according to some particular embodiments, first group key and the second group key are updated during a group key handshake.

Still according to some particular embodiments, the method further comprises creating a privacy security association in a robust security network association, RSNA, between the AP MLD and the non-AP MLD, the first group key and the second group key being stored in the non-AP MLD, in the privacy security association.

Still according to some particular embodiments, the method further comprises deleting the privacy security association storing the first group key and the second group key upon determining an association, reassociation, or dissociation procedure of the non-AP MLD.

Still according to some particular embodiments, the first group key and the second group key are received as wrapped keys with key identifiers in a frame subelement.

According to some embodiments of the disclosure, a new cryptographic group key referred to as Privacy Management Group Temporal Key (PMGTK) is specified and used only for the encryption of encrypt Group addressed management frames, a cryptographic group key being a cryptographic key shared among multiple stations (STAs) associated with the same access point (AP) to secure group-addressed (multicast and broadcast) communication. In particular, PMGTKs correspond to the cryptographic keys that are used by BPE APs affiliated with a BPE AP MLD to encrypt the Frame Body field of the Privacy Beacon.

Still according to some embodiments, the generation and the distribution of the PMGTKs corresponding to the cryptographic keys assigned by an EDP AP MLD that are used by BPE APs affiliated with a BPE AP MLD to encrypt the Group addressed management frames are specified.

According to another aspect of the disclosure, it is provided a processing unit, the processing unit being configured to carry out each of the steps of the method described above.

At least parts of the methods according to some embodiments of the disclosure may be computer implemented. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit”, a “module”, or a “system”. Furthermore, some embodiments of the present disclosure may take the form of a computer program product embodied in any tangible medium of expression having computer usable program code embodied in the medium.

Since some embodiments of the present disclosure can be implemented in software, some embodiments of the present disclosure can be embodied as computer readable code for provision to a programmable apparatus on any suitable carrier medium. A tangible carrier medium may comprise a storage medium such as a floppy disk, a CD-ROM, a hard disk drive, a magnetic tape device or a solid-state memory device, and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Embodiments of the disclosure will now be described, by way of example only, and with reference to the following drawings in which:

FIG. 1 illustrates an example of a network system in which some embodiments of the disclosure may be implemented;

FIG. 2 illustrates a frame format of a Privacy Beacon in accordance with the IEEE 802.11TGbi draft standard.

FIG. 3a schematically illustrates an EDPKE authentication, enabling transmission of a privacy group temporal key according to some embodiments of the disclosure;

FIG. 3b schematically illustrates an IEEE 802.1X authentication, enabling transmission of a privacy group temporal key according to some embodiments of the disclosure;

FIG. 4 schematically illustrates a group key handshake, enabling transmission of a privacy group temporal key according to some embodiments of the disclosure;

FIG. 5 illustrates an example of KDE selector to identify a MLO PMGTK KDE;

FIG. 6 illustrates an example of a MLO PMGTK KDE structure;

FIG. 7 illustrates an example of the format of the MLO PMGTK sub-element, containing a PMGTK, when the BPE non-AP and BPE non-AP MLDs operate a Fast BSS Transition (FT) according to some embodiments of the disclosure

FIG. 8 illustrates an example of a specific value assigned to the MLO PMGTK sub-element when the BPE non-AP and BPE non-AP MLDs operate a Fast BSS Transition (FT) according to some embodiments of the disclosure;

FIG. 9 illustrates an example of the status of the WNM Sleep Mode element;

FIG. 10 illustrates an example of a specific value assigned to the MLO PMGTK sub-element;

FIG. 11 illustrates an example of the format of the MLO PMGTK sub-element, containing the PGTK;

FIG. 12 illustrates an example of the format of the key delivery sub-element, containing a KDE List; and

FIG. 13 schematically illustrates an example of a communication device configured to implement at least some embodiments of the present disclosure.

### DETAILED DESCRIPTION OF THE DISCLOSURE

The inventors have observed that using the same key, here the GTK, for encrypting different type of frames, here data and management frames, according to different purposes, here security and privacy purposes, is not a recommended security practice and could lead to security vulnerabilities such as key compromise (key reuse across different operations or protocols) or cryptographic attacks. Some embodiments of the disclosure make it possible to apply a separation principle according to which each cryptographic key is used for a single and specific purpose.

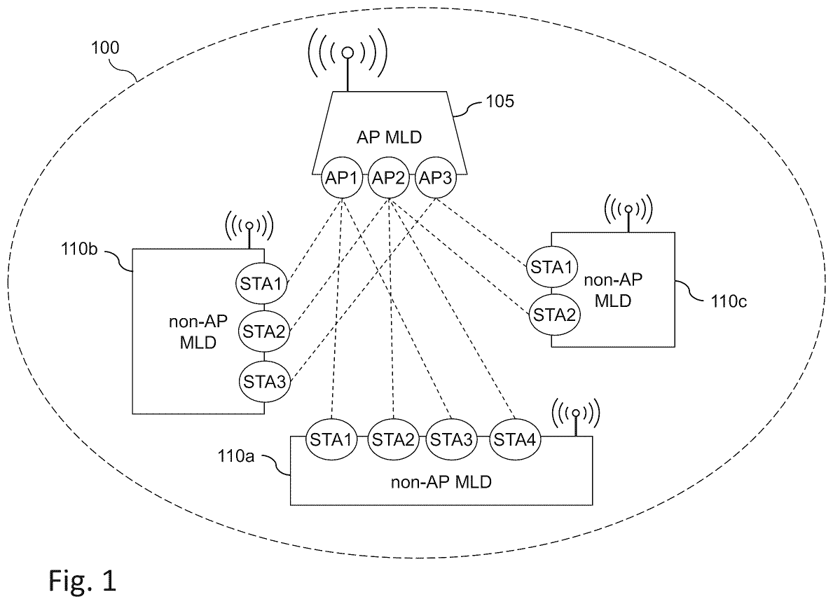

For the sake of illustration, FIG. 1 represents a IEEE 802.11 network (i.e., a Wi-Fi network, WiFi is a trademark) system 100 comprising four wireless devices: an access point station (AP) 105 and three non-AP stations (STAs) 110a, 110b, and 110c. The AP station and the non-AP stations are AP multi-link device (MLD) and non-AP MLDs, respectively, grouping APs referred to as affiliated APs and grouping non-APs referred to as affiliated non-AP STA (also referred to as affiliated stations), respectively. Of course, the number of non-AP MLDs 110a, 110b, and 110c may be different from three. Likewise, the number of affiliated APs per AP MLD and the number of affiliated non-AP STAs per non-AP MLD may vary. As illustrated with dotted lines, AP MLD 105 provides wireless connections between non-AP MLDs 110a, 110b, 110c and a wider network, such as the Internet (not represented).

AP MLD 105 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance in a broadband remote access server (BRAS).

Non-AP MLDs 110a, 110b, and/or 110c may comprise, be implemented as, or known as a subscriber's station, a subscriber unit, a mobile station (MS), a remote station, a remote terminal, a user terminal (UT), a user agent, a user's device, a user equipment (UE), a user station (STA), or some other terminology. In some implementations, a non-AP MLD may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, some of non-AP MLDs 110a, 110b, and 110c may be wireless nodes. Such a wireless node may provide, for example, connectivity for or to a network (e.g., a wide area network such as the Internet or a cellular network) via a wired or wireless communication link.

AP MLD 105 manages a set of stations non-AP MLDs 110a, 110b, and 110c. In the context of the disclosure, AP MLD 105 and its associated non-AP MLDs 110a, 110b, and 110c supports Enhanced Data Privacy (EDP) features referred to as BSS Privacy Enhancement (BPE) features as specified in the IEEE 802.11TGbi draft 1.0 standard and allowing to protect privacy of AP MLD 105 and its associated non-AP MLDs 110a, 110b, and 110c. An AP MLD supporting EDP features is referred to as BPE AP MLD. An AP affiliated with a BPE AP MLD is referred to as BPE AP. A non-AP MLD supporting EDP features is referred to as BPE non-AP MLD. A non-AP STA affiliated with a BPE non-AP MLD is referred to as BPE STA.

The BPE APs affiliated with a BPE AP MLD transmit Privacy Beacon frames 9.3.4.4 (Privacy Beacon frame format) instead of legacy Beacon frames (meaning as specified in the IEEE Std 802.11-2020 standard).

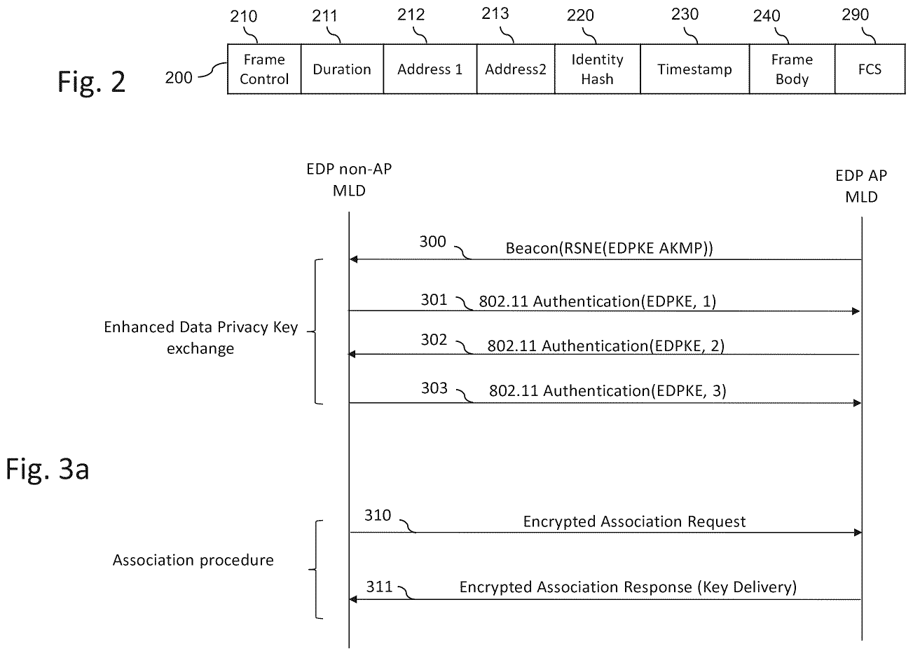

FIG. 2 illustrates a frame format of a Privacy Beacon frame 200 in accordance with the IEEE 802.11TGbi draft 1.0 standard (section 9.3.4.4 (Privacy Beacon frame format)).

As illustrated, Privacy Beacon frame 200 contains a Frame Control field 210, a Duration field 211, an Address 1 field 212, an Address 2 field 213, an Identity Hash field 220, a Timestamp field 230, a Frame Body field 240 and a Frame Check Sequence (FCS) field 290.

A Protected Frame field of the Frame Control field 210 is set if the Privacy Beacon frame is protected (meaning that the Privacy Beacon frame has a Frame Body 240), otherwise it is not set. The Address 1 field 212 is set to the broadcast address. The Address 2 field 213 is set to the anonymized Basic Service Set Identifier (BSSID) as specified in section 10.71.3 of the IEEE 802.11TGbi draft 1.0 standard. The BSSID corresponds to the MAC address of the AP affiliated with the BPE AP MLD transmitting the Privacy Beacon frame.

Identity Hash field 220 is set to a value as described in 10.71.8.1 (BPE AP MLD Discovery) of the IEEE 802.11TGbi draft 1.0 standard. It corresponds to a hash generated from the Address 2 field 213, and a preconfigured or pre-shared Identity Key.

Timestamp field 230 format is described in section 9.4.1.10 (Timestamp field) of the IEEE 802.11-2020 standard and is anonymized as described in 10.71.5.5 (Timestamp anonymization) of the IEEE 802.11TGbi draft 1.0 standard.

Frame Body field 240 of the Privacy Beacon frame contains a list of Information Elements (IE) specified in section 9.3.4.4 (Privacy Beacon frame format) of the IEEE 802.11TGbi draft 1.0 standard.

According to the IEEE 802.11TGbi draft 1.0 standard, the frame body is encrypted by using the group temporal key (GTK) of the AP affiliated with the BPE AP MLD transmitting the Privacy Beacon frame, GTK being used to protect information exchanged in group addressed Data frames, group addressed Data frames including broadcast data frames (data sent to all stations in the BSS) and multicast data frames (data sent to a subset of stations subscribed to that multicast group).

Using the same key for encrypting different type of frames (data/management) and different purposes (security/privacy) is not a recommended security practice and could lead to security vulnerabilities such as key compromise (key reuse across different operations or protocols) or cryptographic attacks. In other words, it violates the key separation principle of using cryptographic keys for a single and specific purpose

The present disclosure introduces new group temporal keys referred to as Privacy Management Temporal Keys (PMGTKs) that are used to the protection of Privacy Beacons transmitted by the BPE APs affiliated with the EDP AP MLD instead of using GTK. A PMGTK is assigned for each BPE AP affiliated with a BPE AP MLD.

As the PMGTK is a group key, like the existing GTK, Integrity GTK (IGTK) and Beacon IGTK (BIGTK) keys, the present disclosure specifies a framework similar to the one used for managing these keys, that is used to manage the PMGTK. This means, in particular, that the PMGTKs of the BPE APs affiliated with a BPE AP MLD are distributed to the BPE STA affiliated with a BPE AP non-AP MLD with the other existing group keys in the Key Delivery element included in the (Re) Association Response frame during the association procedure between the BPE non-AP MLD and the BPE AP MLD and may be updated and distributed later during a Group Key Handshake with the other existing group keys.

To summarize, a privacy management group temporal key (PMGTK) is a random value, that is used by a BPE AP affiliated with a BPE AP MLD to encrypt Group addressed management frame. A payload of a Privacy Beacon frame is encrypted by the PMGTK, and the payload can be decrypted only by the BPE non-AP MLDs associated with the BPE AP MLD of the transmitting BPE AP. To improve the BPE AP privacy, the BPE AP shall use PMGTK to encrypt the payload of the group management frames.

Since PMGTK is used to encrypt management frames, for example privacy beacon frames, of an BPE AP affiliated with a BPE AP MLD, PMGTK operates at a link (affiliated AP) level. According to some embodiments, each BPE AP affiliated with a BPE AP MLD generates its own PMGTK. According to other embodiment, a single PMGTK is generated at the MLD level and is shared with or delivered to each BPE affiliated AP. Accordingly, in such a case, all the AP affiliated with the BPE AP MLD has the same key.

The ciphers relative to PMGTK and used to encrypt the payload of the Group addressed management frames may be the same relative to PGTK, which means that the Group Data Cipher Suite field in the Robust Security Network (RSN) contains the cipher suite selector used in the BSS to protect group addressed Data frames and Group addressed Management frames.

To that end, the circumstances under which each cipher suite is used is now updated by taking into account that both GTK and PMGTK use the same each cipher suite as it is shown in the following table:

| Cipher suite | GTK and | | IGTK or |
|---|---|---|---|
| selector | PMGTK | PTK | BIGTK |
| Use group data | No | Yes | No |
| cipher suite | | | |
| TKIP | Yes | Yes | No |
| CCMP-128 | Yes | Yes | No |
| BIP-CMAC-128 | No | No | Yes |
| GCMP-128 | Yes | Yes | No |
| GCMP-256 | Yes | Yes | No |
| CCMP-256 | Yes | Yes | No |
| BIP-GMAC-128 | No | No | Yes |
| BIP-GMAC-256 | No | No | Yes |
| BIP-CMAC-256 | No | No | Yes |

In particular, a cipher suite selector is not used in the Group Data Cipher Suite field if No is shown in the GTK and PMGTK column for that cipher suite

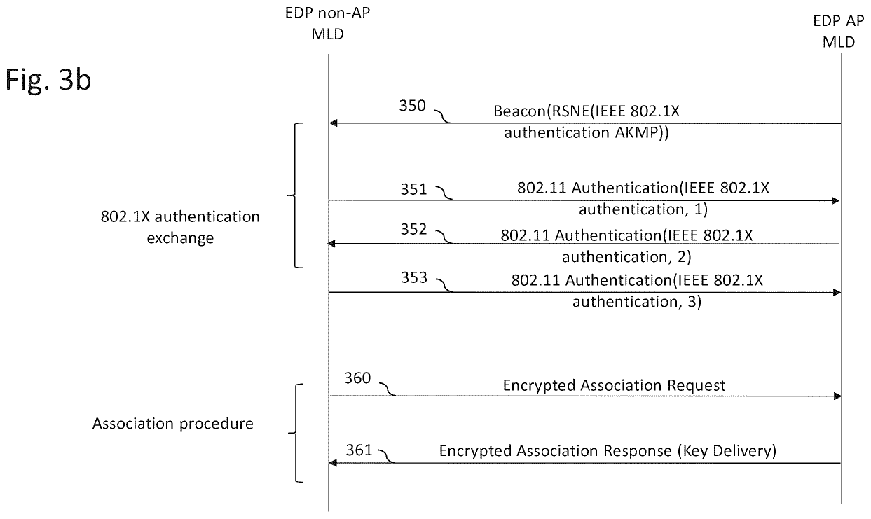

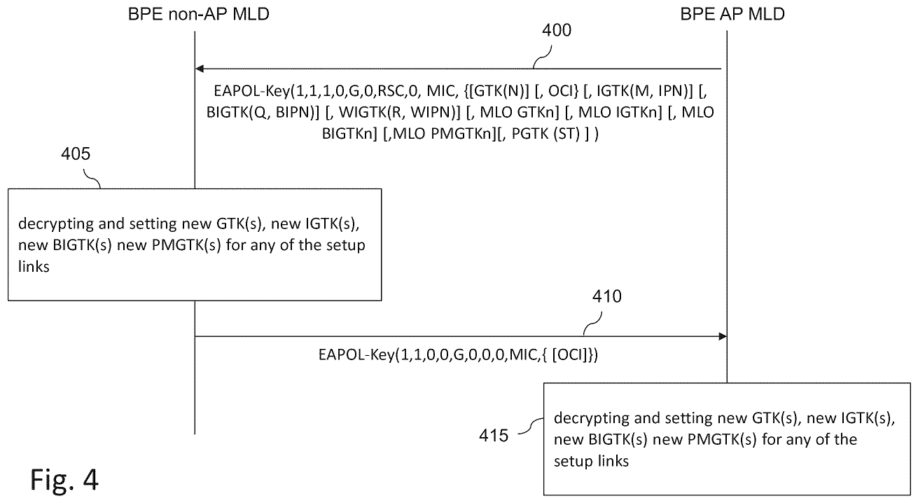

To handle the PMGTK, a new type of security association may be specified, referred to as PMGTKSA (PMTK security association) taking part of Robust Security Network Association (RSNA). It results of a successful group key handshake as illustrated in FIG. 4, the Reassociation Response frame of the fast BSS transition protocol, the encrypted Reassociation Response frame when operating an EDPKE authentication as illustrated in FIG. 3a or an IEEE 802.1X authentication as illustrated in FIG. 3b, or successful FILS authentication.

An Authenticator's Station Management Entity (SME) creates a PMGTKSA when BPE is supported. A PGTKSA has the same lifetime as the BSS, unless superseded. A Supplicant's SME creates a PGTKSA when BPE is supported and the SME receives a PMGTK from its Authenticator. A PMGTKSA consists of a Key ID, the PMGTK and the Authenticator MAC address.

PMGTK is a hierarchy defined in RSNA consisting of a single key used to encrypt the payload of the group management frames. The Authenticator may select the PMGTK as a random value each time it is generated. The Authenticator may update the PMGTK for any reason, including: the disassociation or deauthentication of a STA, an event within the SME that triggers a group key handshake. The PMGTK is configured via the MLME-SETKEYS.request primitive;

The MLME-SETKEYS.request primitive is used to cause the keys identified in the parameters of the primitive to be set in the MAC and enabled for use. The SetKeyDescriptor of the MLME-SETKEYS.request consists of the following parameters:

| Name | Type | Valid range | Description |
|---|---|---|---|
| Key | Bit string | N/A | The temporal key value |
| Length | Integer | N/A | The number of bits in the Key to be |
| | | | used. |
| Key ID | Integer | 0-3 shall be used | Key identifier |
| | | with TKIP, | |
| | | CCMP, and | |
| | | GCMP; | |
| | | 4-5 with BIP for | |
| | | IGTK; 6-7 with | |
| | | BIP for BIGTK; | |
| | | 8-9 with BIP for | |
| | | WIGTK; 10-11 | |
| | | with CCMP for | |
| | | PMGTK and | |
| | | 11-4095 are | |
| | | reserved | |
| Key Type | Enumeration | Group, Pairwise, | Defines whether this key is a GTK, TK, |
| | | PeerKey, IGTK, | TPK-TK, IGTK, BIGTK, WIGTK, |
| | | BIGTK, | PMGTK or PGTK respectively. |
| | | WIGTK, | |
| | | PMGTK, PGTK | |
| Address | MAC | Any valid - | This parameter is valid only when the |
| | address | individual | Key Type value is one of: |
| | | address | Pairwise, |
| | | | Group and the STA is |
| | | | in an IBSS or PBSS (but not an MBSS), |
| | | | PeerKey. |
| Receive Sequence | 8 octets | N/A | Initialization value of the replay |
| Counter | | | counter(s). |
| | | | This parameter is valid only when the |
| | | | Key Type is Group, IGTK, BIGTK, or |
| | | | WIGTK. |

The MLME-SETKEYS.request primitive may operate as follows: when the Key Type is Group, IGTK, BIGTK, or WIGTK, PMGTK, or PGTK and the key matches the GTK, IGTK, BIGTK, or WIGTK, PMGTK, or PGTK, if any, installed as a result of EAPOL-Key PDUs or exiting WNM sleep mode receipt of this primitive shall have no effect except updating the RSC(s) when they are greater than those currently stored. Otherwise, irrespective of the Key Type parameter, when the Key parameter is the same as a key installed as a result of EAPOL-Key PDUs or exiting WNM sleep mode, receipt of this primitive shall have no effect. Otherwise, receipt of this primitive causes the MAC to apply the keys as follows, subject to the MLME-SETPROTECTION.request primitive: the MAC uses the key and key ID for the transmission of subsequent frames to which the key and key ID apply (as defined by the Key Type and Address parameters). When the Key Type parameter is not PGTK, the MAC installs the key with the associated key ID such that received frames for that cipher, of the appropriate type, and containing the matching key ID are processed using that key and its associated state information.

When the Key Type, Key, Key ID, and Address (where valid) parameters identify an existing key, MAC the shall not change the transmitter TSC/PN/IPN/BIPN/WIPN/BPPN counter or the receiver replay counter(s) associated with that key. When the Key Type parameter is not Pairwise, PeerKey, or BIGTK, or PGTK, and the Key, Key ID, and Address (where valid) parameters identify a new key to be set, the MAC shall initialize, depending on the direction of the traffic, the transmitter TSC/PN/IPN/WIPN counter to 0 or 1 or the receiver replay counter(s) to the value in the Receive Sequence Count parameter. When the Key Type, Key, Key ID, and Address (where valid) parameters identify an existing key, the MAC shall not change the transmitter TSC/PN/IPN/BIPN/WIPN/BPPN counter or the receiver replay counter(s) associated with that key.

An SME establishes an RSNA in one of several ways. More precisely,
if an RSNA uses authentication negotiated over IEEE Std 802.1X or FILS authentication in a infrastructure BSS and if the Group EDP epoch is supported by both the AP MLD and the non-AP MLD, the SME programs the PMGTK and PMPN into the MAC for the encryption of Group addressed management frames.
if an RSNA is based on a PSK or password in a infrastructure BSS and if the Group EDP epoch is supported by both the AP MLD and the non-AP MLD, the SME programs the PMGTK and PMPN into the MAC for the encryption of Group addressed management frames.
if the Group EDP epoch is supported by both the AP MLD and the non-AP MLD and if an RSNA allows for confidentiality only (no authentication) in a infrastructure BSS, the SME programs the SME programs the PMGTK and PMPN into the MAC for the encryption of Group addressed management frames.

The procedures used for IEEE 802.11 Association, reassociation, and disassociation should also handle the PMGTK.

More precisely, concerning the non-AP STA, non-AP MLD, and non-PCP STA association initiation procedures, the SME should delete any PTKSA, GTKSA, IGTKSA, BIGTKSA, WIGTKSA, WTKSA, PMGTKSA, PGTKSA, and TPKSA (including temporal keys) held for communication with the AP MLD by using MLME-DELETEKEYS.request primitive (see 12.6.16 (RSNA security association termination)) before invoking MLME-ASSOCIATE.request primitive.

The MLME-DELETEKEYS.request primitive is used to reinforce the security and may be used, in each involved STA, to delete the temporal key(s) established for the security association, so that they cannot be used to protect subsequent IEEE 802.11 traffic. An SME uses this primitive when it deletes a PTKSA, GTKSA, IGTKSA, BIGTKSA, PMGTKSA, PGTKSA, WIGTKSA or TPKSA

The DeleteKeyDescriptor of the MLME-DELETEKEYS.request may consist in the following parameters:

| Name | Type | Valid range | Description |
|---|---|---|---|
| Key ID | Integer | 0-3 shall be used | Key identifier. |
| | | with TKIP, | |
| | | CCMP, and | |
| | | GCMP; | |
| | | 4-5 with BIP for | |
| | | IGTK; 6-7 with BIP | |
| | | for BIGTK; (11ba)8- | |
| | | 9 with BIP for | |
| | | WIGTK; and | |
| | | 10-4095 are reserved | |
| Key Type | Enumeration | Group, Pairwise, | Defines whether this key is a GTK, TK, |
| | | PeerKey, IGTK, | TPK-TK, IGTK, BIGTK, [symbol] WIGTK, |
| | | BIGTK, WIGTK, | PMGTK or PGTK respectively. |
| | | PMGTK, PGTK | |
| Address | MAC address | Any valid individual | This parameter is valid only when the Key |
| | | address | Type value is one of: |
| | | | Pairwise, |
| | | | Group and the STA or MLD is in an |
| | | | IBSS or PBSS (but not an MBSS), |
| | | | PeerKey. |
| Encapsulation | Enumeration | Normal, BCE | This parameter is valid only when the Key |
| Mode | | | Type value is BIGTK |

Similarly, concerning the AP, AP MLD, or PCP association receipt procedures, upon receipt of an Association Request frame from a STA or by an AP MLD after an AP affiliated with the AP MLD receives an Association Request frame with Basic Multi-Link element from a non-AP STA affiliated with a non-AP MLD: if the ResultCode in the MLME-ASSOCIATE.response primitive is SUCCESS, the SME shall delete any PTKSA, GTKSA, IGTKSA, BIGTKSA, WIGTKSA, WTKSA, PMGTK, PGTKSA and TPKSA (including temporal keys) held for communication with the STA or non-AP MLD by using the MLME-DELETEKEYS.request.

Similarly, concerning the non-AP STA, non-AP MLD, and non-PCP STA reassociation initiation procedures, except when the association is part of a fast BSS transition, the SME should delete any PTKSA, GTKSA, IGTKSA, BIGTKSA, WIGTKSA, WTKSA, PMGTKSA, PGTKSA and TPKSA (including temporal keys) held for communication with the AP, AP MLD, or PCP by using the MLME-DELETEKEYS.request primitive before invoking an MLME-REASSOCIATE.request primitive.

Similarly, concerning the AP, AP MLD, or PCP reassociation receipt procedures, upon receipt of a Reassociation Request frame from a STA or by an AP affiliated with an AP MLD upon receipt of a Reassociation Request frame with Basic Multi-Link element from a non-AP STA affiliated with a non-AP MLD, and if management frame protection is not in use, or the ResultCode in the MLME-REASSOCIATE.response primitive is SUCCESS and the reassociation is not part of a fast BSS transition, the SME shall delete any PTKSA, GTKSA, IGTKSA, BIGTKSA, WIGTKSA, WTKSA, PMGTKSA, PGTKSA and TPKSA (including temporal keys) held for communication with the STA or the non-AP MLD by using the MLME-DELETEKEYS.request primitive.

Similarly, concerning the non-AP STA, non-AP MLD, and non-PCP STA disassociation initiation procedures, upon receipt of an MLME-DISASSOCIATE.request primitive, a non-AP STA, non-AP MLD, and non-PCP STA's MLME shall disassociate from an AP, AP MLD, or PCP, respectively, and upon receiving an MLME-DISASSOCIATE.confirm primitive, the SME shall delete any PTKSA, GTKSA, IGTKSA, BIGTKSA, WIGTKSA, WTKSA, PMGTKSA, PGTKSA and TPKSA (including temporal keys) held for communication with the AP, AP MLD or PCP by using the MLME DELETEKEYS.request primitive (see 12.6.16 (RSNA security association termination)) and by invoking an MLME-SETPROTECTION.request (None) primitive. In the case of an MM-SME coordinated STA, the MLME shall perform this for each STA whose address was included in the MMS parameter of the MLME-ASSOCIATE.request or MLME-REASSOCIATE.request primitive that established the association.

Similarly, concerning the non-AP STA, non-AP MLD, and non-PCP STA disassociation receipt procedure, Upon receipt of a Disassociation frame from an AP, AP MLD, or PCP for which the state is State 3 or State 4, if management frame protection was not negotiated when the PTKSA(s) were created, or if management frame protection was negotiated when the PTKSA(s) were created and the frame is not discarded per management frame protection processing, a non-AP STA, non-AP MLD, and non-PCP STA, respectively, shall disassociate from the AP, AP MLD, or PCP and upon receiving the MLME-DISASSOCIATE.indication primitive, the SME shall delete any PTKSA, GTKSA, IGTKSA, BIGTKSA, WIGTKSA, WTKSA, PMGTKSA, PGTKSA and TPKSA (including temporal keys) held for communication with the AP, AP MLD or PCP by using the MLME DELETEKEYS.request primitive (see 12.6.16 (RSNA security association termination)) and by invoking an MLME-SETPROTECTION.request (None) primitive. The MM-SME shall perform this process for each STA whose address was included in the MMS parameter of the MLME-ASSOCIATE.request r MLME-REASSOCIATE.request primitive that established the association.

Similarly, concerning the AP, AP MLD, or PCP disassociation initiation procedure, Upon receipt of an MLME-DISASSOCIATE.request primitive, an AP, AP MLD, or PCP shall disassociate a STA (with respect to the AP or PCP) or a non-AP MLD (with respect to the AP MLD) and upon receiving an MLME-DISASSOCIATE.confirm primitive, the SME shall delete any PTKSA, GTKSA, IGTKSA, BIGTKSA, WIGTKSA, WTKSA, PMGTKSA, PGTKSA and TPKSA (including temporal keys) held for communication with the STA by using the MLME DELETEKEYS.request primitive (see 12.6.16 (RSNA security association termination)) and by invoking an MLME-SETPROTECTION.request (None) primitive. The MM-SME shall perform this process for each STA whose address was included in the MMS parameter of the MLME-ASSOCIATE.request or MLME-REASSOCIATE.request primitive that established the association.

Similarly, concerning the AP, AP MLD, or PCP disassociation receipt procedure, upon receipt of a Disassociation frame from a STA or a non-AP MLD for which the state is State 3 or State 4, if management frame protection was not negotiated when the PTKSA(s) were created, or if management frame protection was negotiated when the PTKSA(s) were created and the frame is not discarded per management frame protection processing, the AP or PCP (with respect to the STA) or AP MLD (with respect to the non-AP MLD) should disassociate the STA or the non-AP MLD, upon receiving an MLME-DISASSOCIATE.indication primitive and the SME should delete any PTKSA, GTKSA, IGTKSA, BIGTKSA, WIGTKSA, WTKSA, PGTKSA and TPKSA (including temporal keys) held for communication with the STA by using the MLME DELETEKEYS.request primitive and by invoking an MLME-SETPROTECTION.request (None) primitive. The MM-SME should perform this process for each STA whose address was included in the MMS parameter of the MLME-ASSOCIATE.request or MLME-REASSOCIATE.request primitive that established the association.

During RSNA security association termination, when a non-AP STA's SME receives a successful MLME-ASSOCIATE.confirm or MLME-REASSOCIATE.confirm primitive that is not part of a fast BSS transition or receives or invokes an MLME Disassociation or Deauthentication primitive, it may delete some security associations. Similarly, when an AP's SME receives an MLME-ASSOCIATE.indication or MLME-REASSOCIATE.indication primitive from a STA that has not negotiated management frame protection, it deletes some security associations.

Likewise, when an AP's SME receives an MLME-ASSOCIATE.indication or MLME-REASSOCIATE.indication primitive from a STA that has negotiated management frame protection that a) has resulted in an MLME (re) association response that is successful, and b) is not part of a fast BSS transition, or receives an MLME-DEAUTHENTICATE.indication or MLME-DISASSOCIATE.indication primitive or issues an MLME-DEAUTHENTICATE.request or MLME-DISASSOCIATE.request primitive, it deletes some security associations.

In the case of an ESS, the non-AP STA's SME shall delete any PTKSA(s), GTKSA(s), IGTKSA(s), BIGTKSA(s), WIGTKSA(s), WTKSA(s), TPKSA(s), PMGTKSA(s), the non-AP MLD's SME shall delete any PGTKSA(s) and the AP's SME shall delete the PTKSA. In the case of an IBSS, the SME shall delete the PTKSA(s) and the GTKSA(s) and any IGTKSA(s). Once the security associations have been deleted, the SME then invokes the MLME-DELETEKEYS.request primitive to delete all temporal keys associated with the deleted security associations.

FIG. 3a schematically illustrates an EDPKE authentication, enabling transmission of a privacy group temporal key according to some embodiments of the disclosure.

The EDPKE authentication allows for the protection of management frames without association by establishing a PTKSA using authentication frames.

The establishment of an EDPKE authentication between an EDP non-AP MLD and a EDP AP MLD is based on an Enhanced Data Privacy Key exchange including the messages 300, 301, 302 and 303, as specified in section 12.14.8 (Enhanced Data Privacy Key Exchange) of the IEEE P802.11bi™/D0.6 draft standard.

From a successful EDPKE authentication, a Pairwise Transient Key (PTK) is derived, as specified in section 12.14.8.3.4 (PTKSA derivation with EDPKE authentication) of the IEEE P802.11bi™/D0.6 draft standard, including a temporal key (TK), both being used to encrypt the (Re) Association Request frame 310 and (Re) Association Response 311 during the association procedure.

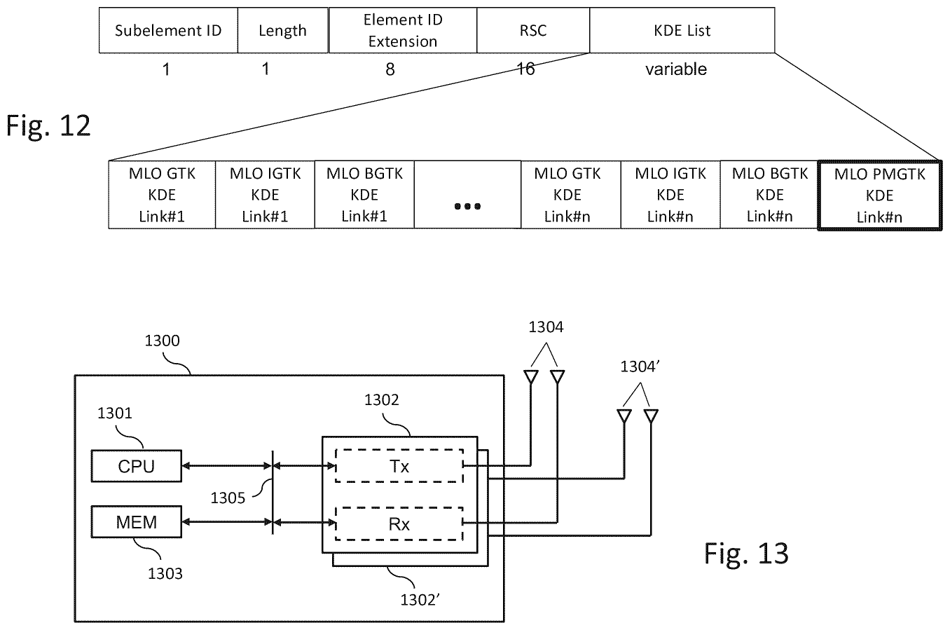

If a Key delivery element is included in the (Re) Association Response frame, the EDP AP MLD shall construct the Key Delivery element with the RSC field set to 0, with the MLO (Multi-Link Operation) GTK KDE for each setup link, with the MLO IGTK KDE for each setup link if management frame protection is negotiated, with the MLO BIGTK KDE for each setup link if beacon protection is enabled, with the MLO PMGTK KDE as illustrated in FIG. 12 for each setup link if BPE is supported, with the PGTK KDE if EDP epoch is supported by both AP MLD and non-AP MLD.

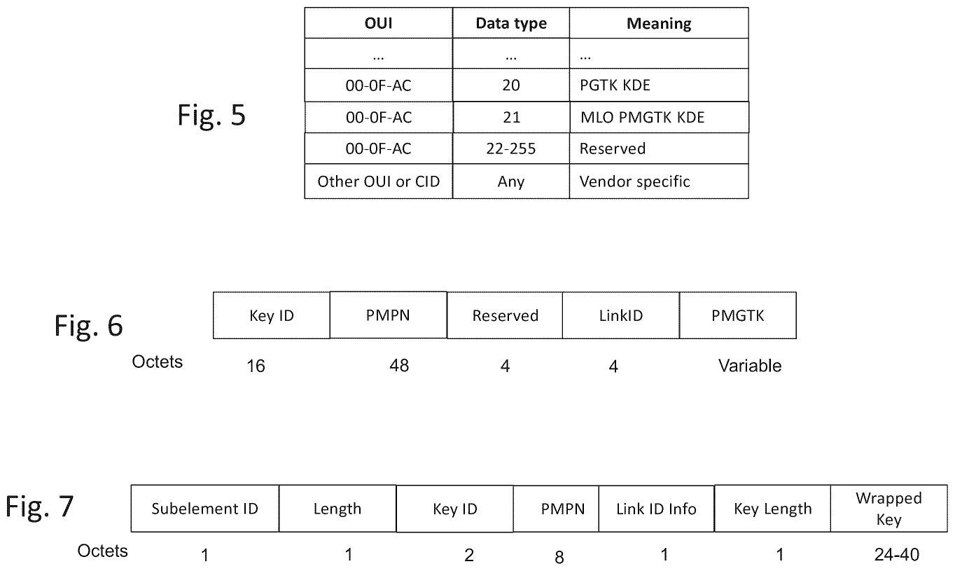

More precisely, the PMGTK KDE is identified with a specific KDE selector, for example a new KDE selector in Table 12-10-KDE selector of the IEEE P802.11REVme™/D7.0 standard. For instance, an Organizationally Unique Identifier set to 00-OF-AC and a Data type set to value 21 may be used to identify a PGTK KDE, as illustrated in FIG. 5.

As illustrated in FIG. 6, a MLO PMGTK KDE may contain a Key ID field, a PMPN field, a Reserved field, a LinkID field and a PMGTK field. The Key ID field contains the IGTK key ID. The PMPN field contains the PMPN. The PMPN field contains the last PMPN used by the transmitter, and it is used by the receiver as the initial value for the replay counter for the PMGTK. The PMGTK field contains the PMGTK. The LinkID field contains the link identifier that corresponds to the link this PMGTK applies.

The EDP non-AP MLD should decrypt the (Re) Association Response frame 311 received from the EDP AP MLD using the TK and the pairwise cipher indicated during the Enhanced Data Privacy Key exchange. If the decryption fails, then the association exchange fails. On successful (re) association, the EDP non-AP MLD installs the GTK and GTK RSC, and IGTK and IGTK RSC if management frame protection is enabled, and BIGTK and BIGTK RSC if present in the Key Delivery element and dot11BeaconProtectionEnabled is true, and PMGTK and PMGTK RSC if BPE is supported, and PGTK if EDP epoch is supported by both AP MLD and non-AP MLD.

FIG. 3b schematically illustrates an IEEE 802.1X authentication, enabling transmission of a privacy group temporal key according to some embodiments of the disclosure.

The IEEE 802.1X authentication allows for the protection of Management frames without association by establishing a PTKSA using authentication frames.

The establishment of an IEEE 802.1X authentication between an EDP non-AP MLD and an EDP AP MLD is based on an IEEE 802.1X authentication exchange including the messages 350, 351, 352 and 353 as specified in the section 12.14.8 (Enhanced Data Privacy Key Exchange) of the IEEE P802.11bi™/D0.6 draft standard.

From a successful IEEE 802.1X authentication, a Pairwise Transient Key (PTK) is derived, as specified in section 12.14.4 (IEEE 802.1X authentication utilizing Authentication frames) of IEEE P802.11bi™/D0.6 draft standard, including a temporal key (TK), both being used to encrypt the (Re) Association Request frame 360 and (Re) Association Response 361 during the association procedure.

The EDP AP MLD includes a Key delivery element in the (Re) Association Response frame 361 and if a Key delivery element is included in the (Re) Association Response frame, the EDP AP MLD shall construct the Key Delivery element with the RSC field set to 0, with the MLO GTK KDE for each setup link, with the MLO IGTK KDE for each setup link if management frame protection is negotiated, with the MLO BIGTK KDE for each setup link if beacon protection is enabled, with the MLO PMGTK KDE as illustrated in FIG. 12 for each setup link if BPE is supported, with the PGTK KDE if EDP epoch is supported by both AP MLD and non-AP MLD.

The EDP non-AP MLD should decrypt the (Re) Association Response frame 361 received from the EDP AP MLD using the TK and the pairwise cipher indicated during the IEEE 802.1X authentication exchange. If the decryption fails, then the association exchange fails. On successful (re) association, the EDP non-AP MLD installs the GTK and GTK RSC, and IGTK and IGTK RSC if management frame protection is enabled, and BIGTK and BIGTK RSC if present in the Key Delivery element and dot11BeaconProtectionEnabled is true, and PMGTK and PMGTK RSC if BPE is supported, and PGTK if EDP epoch is supported by both AP MLD and non-AP MLD.

FIG. 4 schematically illustrates a group key handshake, enabling transmission of a privacy group temporal key according to some embodiments of the disclosure.

When a non-AP and non-PCP STA operates an RSNA rekeying (PCP standing for PBSS control point and PBSS standing for personal basic service set), an Authenticator may initiate a group key handshake for the purpose of GTK rekeying (with a GTKSA), IGTK keying (with an IGTKSA), BIGTK rekeying (with a BIGTKSA), PMGTK rekeying (with a PBGTSA), PGTK rekeying (with a PGTKSA) or WIGTK rekeying (with a WIGTKSA). For MLO, the AP MLD's Authenticator manages packet number assignment for the PTKSA with a non-AP MLD. For a given link, the affiliated AP's Authenticator manages packet number assignment for the IGTKSA, GTKSA, or BIGTKSA. If an IGTKSA, GTKSA, PMGTKSA or BIGTKSA update is triggered, the affiliated AP updates group keys for the given link through a group key handshake between the AP MLD and non-AP MLD

More precisely, when the Authenticator is an AP MLD and the Supplicant is a non-AP MLD, the Authenticator uses the Group key handshake to send a new GTK and, if management frame protection is negotiated, a new IGTK, and if beacon protection is enabled, a new BIGTK, and if WUR frame protection is negotiated, a new WIGTK, and if BPE is supported, a new PMGTK, to the Supplicant. When the Authenticator is an AP MLD and the Supplicant is a non-AP MLD, the Authenticator may also use the Group key handshake to send new GTK(s) for any of the setup links and, if management frame protection is negotiated, new IGTK(s) for any of the setup links, and if beacon protection is enabled, new BPTK(s) for any of the setup links, and if BPE is supported, new BIGTK(s) for any of the setup links to the Supplicant and if EDP epoch is supported by both AP MLD and non-AP MLD, a new PGTK.
a. It is recalled that IEEE Std 802.11 standard uses EAPOL-Key PDUs (EAPOL standing for extensible authentication protocol over LANs, LAN standing for local area network, and PDU standing for protocol data unit), each carried in one or more EAPOL-Key frames, to exchange items of information between supplicants, for example an BPE non-AP, and authenticators, for example an BPE AP. These exchanges result in cryptographic keys and synchronization of security association state. EAPOL-Key PDUs make it possible to update the GTK and the PMGTK (during a group key handshake).

As illustrated in FIG. 4, a first step of a group key handshake is directed to transmitting a first encrypted EAPOL-Key frame 400, from the EDP AP MLD to the EDP non-AP MLD. The encrypted EAPOL-Key frame 400 includes new GTK(s) for any of the setup links and, if management frame protection is negotiated, new IGTK(s) for any of the setup links, and if beacon protection is enabled, new BPTK(s) for any of the setup links, and if BPE is supported, new BIGTK(s) for any of the setup links to the Supplicant and if EDP epoch is supported by both AP MLD and non-AP MLD, a new PGTK. To that end, the EAPOL-Key frame may include a MLO PMGTK KDE identified with a specific KDE selector, for example a new KDE selector in Table 12-10-KDE selector of the IEEE P802.11REVme™/D7.0 standard. For instance, an Organizationally Unique Identifier set to 00-OF-AC and a Data type set to value 21 may be used to identify a PMGTK KDE, as illustrated in FIG. 5.

As illustrated in FIG. 6, a MLO PMGTK KDE may contain a Key ID field, a PMPN field, a Reserved field, a LinkID field and a PMGTK field. The Key ID field contains the IGTK key ID. The PMPN field contains the PMPN. The PMPN field contains the last PMPN used by the transmitter, and it is used by the receiver as the initial value for the replay counter for the PMGTK. The PMGTK field contains the PMGTK. The LinkID field contains the link identifier that corresponds to the link this PMGTK applies.

In that way, the encrypted EAPOL-Key frame 400 includes, for MLO, when present, the MLO PMGTK KDE for each of the setup links with a new PMGTK.

The EAPOL-Key frame 400 may be expressed as follows:

EAPOL-Key (1,1,1,0,G,0,RSC,0, MIC, {[GTK(N)] [, OCI} [, IGTK (M, IPN)] [, BIGTK(Q, BIPN)] [, WIGTK(R, WIPN)] [, MLO GTKn] [, MLO IGTKn] [, MLO BIGTKn] [, PGTK(ST)]) wherein MLO PMGTKn, when present, denotes the PMGTK for the AP affiliated with the AP MLD for the link specified by LinkID n.

Upon reception of message 400, at step 405, the supplicant (e.g., the BPE non-AP MLD) decrypts the message and sets new GTK(s) for any of the setup links and, if management frame protection is negotiated, new IGTK(s) for any of the setup links, and if beacon protection is enabled, new BPTK(s) for any of the setup links, and if BPE is supported, new BIGTK(s) for any of the setup links to the Supplicant and if EDP epoch is supported by both AP MLD and non-AP MLD, a new PGTK. To that end, when the Supplicant is a non-AP MLD, it uses the MLME-SETKEYS.request primitive to configure the GTK(s) when present and, the IGTK(s) when present, and the BIGTK(s), and the PMGTK(s) when present for the indicated link(s) into the MAC of the affiliated non-AP STA(s) operating on the indicated link(s).

At the reception of message 400 and in addition to decrypting and updating the PTK(s), GTK(s), IGTK(s), PMGTK(s) and PGTK, the BPE non-AP MLD sends a second message 410 comprising an acknowledgment and the Message Integrity Code (MIC).

Upon receiving message 410, at step 415, the AP MLD computes the MIC using the Key Confirmation Key (KCK). Next, it compares the received MIC to the computed MIC. If the received MIC is the same as the computed MIC, the non-AP MLD and the AP MLD have the same Pairwise Temporal Key (PTK). In such a case, the AP MLD sets new GTK(s) for any of the setup links and, if management frame protection is negotiated, new IGTK(s) for any of the setup links, and if beacon protection is enabled, new BPTK(s) for any of the setup links, and if BPE is supported, new BIGTK(s) for any of the setup links to the Supplicant and if EDP epoch is supported by both AP MLD and non-AP MLD, a new PGTK. To that end, when the Supplicant is a non-AP MLD, it uses the MLME-SETKEYS.request primitive to configure the GTK(s) when present and, the IGTK(s) when present, and the BIGTK(s), and the PMGTK(s) when present for the indicated link(s) into the MAC of the affiliated non-AP STA(s) operating on the indicated link(s).

### FILS Authentication

When the BPE non-AP MLD (also referred to as FILSO) operates a FILS authentication with an BPE AP (also referred to as FILSR), FILSO and FILSR perform a key establishment using Authentication frames and perform a key confirmation using (Re) Association Request and (Re) Association Response frames.

Upon receiving a (Re) Association Request for a FILS key confirmation, the FILSR constructs a Key Delivery element indicating the current GTK and GTK PN, and the current IGTK and IPN if management frame protection is enabled, and the current BIGTK and BIPN if beacon protection is enabled, and the current WIGTK and WIPN if WUR frame protection is enabled, and the current PMGTK and PMPN if BPE is supported, and the current PGTK if EDP epoch is supported by both AP MLD and non-AP MLD. For non-MLO, the GTK is carried in a GTK KDE. The IGTK and IPN are carried in an IGTK KDE, the BIGTK and BIPN are carried in a BIGTK KDE and the WIGTK and WIPN are carried in a WIGTK KDE. For MLO, the PGTK is carried in a PGTK KDE, GTKs for all setup links are carried in MLO GTK KDEs, the IGTKs in MLO IGTK KDEs, and the BIGTKs in MLO BIGTK KDEs, and the PMGTKs in MLO PMGTK KDEs.

At the reception of the (Re) Association Response frame for FILS authentication, Upon successful completion of the FILS authentication procedure, the FILSO shall process the Key Delivery element in the (Re) Association Response frame. For MLO, the FILSO installs the PGTK and installs GTKs, IGTKs and BIGTKs, PMGTKs for each setup link.

### Fast BSS Transition

When the BPE non-AP MLD operates a Fast BSS Transition (FT), the security key holders (KHs) which implement the specific security functions such as keys generation and distribution should also handle the PMGTK(s).

In particular, if BPE is supported by both the AP MLD and the non-AP MLDs, the R1KH (R1 Key Holders physically located in each AP of the mobility domain) the R1KH shall distribute the GTKs, IGTKs and PMGTKs for setup links to all connected non-AP MLDs.

When an BPE non-AP MLD operates the FT authentication sequence in order to roam from an BPE non-AP MLD to another BPE non-AP MLD, the fourth message of the sequence containing the group keys should now include the PMGTK(s). To that end, the Fast BSS Transition element (FTE) should be set as follows: when this message of the authentication sequence appears in a Reassociation Response frame, the Optional Parameter(s) field in the FTE may include the GTK, IGTK, BIGTK, WIGTK subelements or PGTK, MLO GTK, MLO IGTK, and MLO BIGTK and MLO PMGTK subelements. If a GTK, an IGTK, a BIGTK, WIGTK, a PGTK, an MLO GTK, an MLO IGTK or, an MLO BIGTK or an MLO PMGTK are included, the Key field of the subelement shall be wrapped using PTK-KEK or KEK2 and the appropriate key wrap algorithm. The padding consists of appending a single octet Oxdd followed by zero or more 0x00 octets. When processing a received message, the receiver shall ignore this trailing padding. Addition of padding does not change the value of the Key Length field. Note that the length of the encrypted Key field can be determined from the length of the GTK, IGTK, BIGTK, PGTK, WIGTK, MLO GTK, MLO IGTK, or MLO BIGTK, or MLO PMGTK subelement.

The MLO PMGTK subelement contains the PMGTK for a link, used for encrypting Group addressed management frame. More precisely, as illustrated in FIG. 7, the PGTK sub-element may contain a Subelement ID field, a length field, a Key ID field, a PMPN field, a Link ID Info field, a Key Length field and a Wrapped Key field.

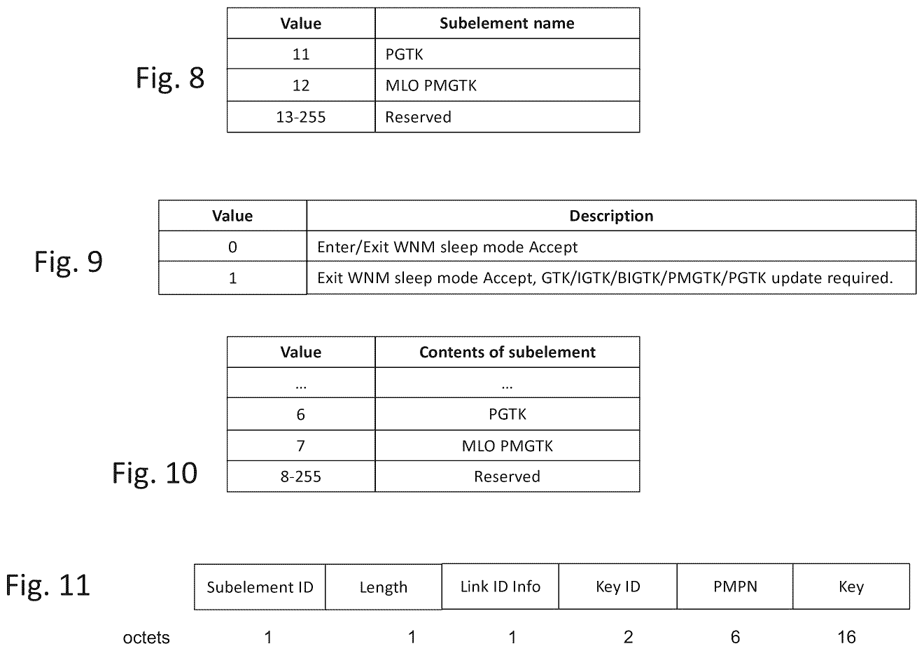

The Sub-element ID field identifies the FTE sub-elements and is defined in Table 9-221-Sub-element IDs of the IEEE P802.11REVme™/D7.0 standard. A specific value that was reserved until now may be assigned to MLO BIGTK sub-element, like the value 12, as illustrated in FIG. 8.

The Key ID field contains the PMGTK key ID.

The PMPN field contains the current RSC for the PMGTK being installed. The RSC for an PMGTK is the PMGTK packet number (PMPN).

The Key Length field is the length of PMGTK in octets, not including any padding.

The Wrapped Key field contains the wrapped PMGTK being distributed.

The definition of the Link ID Info field is the same as in the MLO GTK subelement specified in the standard IEEE Std 802.11-2020.

In a case according to which the FT resource request protocol is used, which involves an additional message exchange after the Authentication-Request/Response frame, or FT Request/Response frame, and prior to reassociation, the security key holders (KHs) should also handle the PMGTK(s).

In such a case, when the Over-the-air fast BSS transition with resource request is used, in an RSN, on successful completion of the FT authentication exchange of the FT resource request protocol, the PTKSA has been established and proven live. The key replay counter shall be initialized to 0, and the subsequent EAPOL-Key PDUs (e.g., GTK, IGTK, BIGTK, PGTK, PMGTK and WIGTK updates) shall use the key replay counter to detect and discard replays. The PTKSA shall be deleted by the target FTR if it does not receive a Reassociation Request frame from the FTO within the reassociation deadline timeout value

Similarly, when Over-the-DS fast BSS transition with resource request is used, in an RSN, on successful completion of the FT Confirm/Acknowledgment frame exchange, the PTKSA has been established and proven live. The key replay counter shall be initialized to 0, and the subsequent EAPOL-Key frames (e.g., GTK, IGTK, BIGTK, and WIGTK, PMGTK and PGTK updates) shall use the key replay counter to detect and discard replays. The PTKSA shall be deleted by the target FTR if it does not receive a Reassociation Request frame from the FTO within the reassociation deadline timeout value.

In the case of a FT reassociation, the security key holders (KHs) should also deal with also the PMGTK(s). To that end, if the FTO does not send a Reassociation Request frame to the target AP within the reassociation deadline interval received during the FT initial mobility domain association, the target AP may delete the PTKSA, and the FTO should abandon this transition attempt. The FTO should perform a reassociation directly with the target FTR, for example according to the following exchange:

FTO→Target FTR: Reassociation Request(RSNE[PMKR1Name], MDE, FTE[MIC, ANonce, SNonce, R1KH-ID, ROKH-ID], RIC-Request, RSNXE, Basic Multi-Link element)

Target FTR→FTO: Reassociation Response(RSNE[PMKR1Name], MDE, FTE[MIC, ANonce, SNonce, R1KH-ID, ROKH-ID, GTK[N], IGTK[M], BIGTK[Q], WIGTK[R], PGTK, MLO GTKn, MLO IGTKn, MLO BIGTKn, MLO PMGTKn], RIC-Response, RSNXE, Basic Multi-Link element) wherein
MLO GTK is the MLO GTK subelement for the AP affiliated with the AP MLD for the link specified by the value in the Link ID field,
MLO IGTK is the MLO IGTK subelement for the AP affiliated with the AP MLD for the link specified by the value in the Link ID field,
MLO BIGTK is the MLO BIGTK subelement for the AP affiliated with the AP MLD for the link specified by the value in the Link ID field,
MLO PMGTK is the MLO PMGTK subelement for the AP affiliated with the AP MLD for the link specified by the value in the Link ID field.
the GTK[N], IGTK[M], BIGTK[Q] are present when the FTR is an AP, and
The MLO GTKn, MLO IGTKn, MLO BIGTKn, MLO PMGTKn, PGTK and the Basic Multi-Link element are present when the FTR is an AP MLD.

### Wireless Network Management (WNM) Sleep Mode

The Wireless Network Management (WNM) sleep mode should also handle the PMGTKs when the AP MLD is a BPE AP MLD and the non-AP MLDs are BPE non-AP MLDs.

The extended power save mode for non-access point (non-AP) stations (STAs) and non-AP multi-link devices (non-AP MLDs) whereby a non-AP STA or non-AP STAs affiliated with a non-AP MLD need not listen for every delivery traffic indication map (DTIM) beacon and do not perform group temporal key/integrity group temporal key/beacon integrity group temporal key (GTK/IGTK/BIGTK) updates, the non-AP MLD needs not perform privacy group temporal key (PGTK) updates. In other words, WNM sleep mode enables an extended power save mode in which a non-AP STA needs not listen for every DTIM beacon, and does not need to perform GTK/IGTK/BIGTK updates. Further, the non-AP MLD does not need to perform PGTK updates.

In other words, WNM sleep mode is an extended power save mode for non-AP STAs in which a non-AP STA or all STAs affiliated with a non-AP MLD need not listen for every DTIM beacon, and need not perform GTK/IGTK/BIGTK/PMGTK updates. For non-MLO, WNM sleep mode enables a non-AP STA to signal to an AP that it might sleep for a specified length of time. For MLO, WNM sleep mode enables a non-AP STA affiliated with the non-AP MLD to signal to an AP affiliated with the AP MLD that all the non-AP STAs affiliated with the non-AP MLD might transition to doze state for a specified length of time. This enables a non-AP STA or a non-AP MLD to reduce power consumption and remain associated while the non-AP STA or the non-AP MLD has no traffic to send to or receive from the AP or AP MLD.

For MLO, WNM sleep mode enables a non-AP STA affiliated with the non-AP MLD to signal to an AP affiliated with the AP MLD that all the non-AP STAs affiliated with the non-AP MLD might transition to doze state for a specified length of time. This enables a non-AP STA or a non-AP MLD to reduce power consumption and remain associated while the non-AP STA or the non-AP MLD has no traffic to send to or receive from the AP or AP MLD.

The WNM sleep state is maintained by the MLD and the WNM sleep mode procedures are performed at the MLD level and apply to all the STAs affiliated with the MLD.

The enter and the exit of a WNM sleep mode of a non-AP MLD is operated with an exchange of WNM Sleep Mode Request/Response frames between the non-AP MLD and the AP MLD through their respective affiliated STA and AP over a setup link.

When a non-AP MLD (in WNM sleep mode) initiates an WNM sleep mode exit, it transmits a WNM Sleep Mode Request including a WNM Sleep Mode element for which the Action Type field is set to 1 indicating an Exit WNM sleep mode.

When an AP MLD receives a WNM Sleep Mode Request frame from a non-AP MLD via one of its affiliated APs, the AP MLD should, in response, send a WNM Sleep Mode Response frame, via one of its affiliated APs operating on a link that is enabled for the non-AP MLD and subject to the power state of the non-AP STA affiliated with the non-AP MLD and operating on that link. An AP MLD may also send, via one of its affiliated APs that is operating on an enabled link for the non-AP MLD and subject to the power state of the non-AP STA affiliated with the non-AP MLD and operating on that link, the WNM Sleep Mode Response frame without solicitation upon the AP MLD's deletion of all traffic filter sets established according to the traffic filtering agreement between the AP MLD and the non-AP MLD.

The WNM Sleep Mode Response frame transmitted by the AP MLD includes a WNM Sleep Mode element for which the WNM Sleep Mode Response Status is set to 0 when the Exit WNM sleep mode is accepted and 1 when the Exit WNM sleep mode is accepted and requires also the GTK/IGTK/BIGTK/PMGTK/PGTK update, as illustrated in FIG. 9.

When the GTK/IGTK/BIGTK/PMGTK/PGTK update is required, the Key Data field contains zero or more subelements that provide the current GTK, IGTK, BIGTK, PMGTK to the STA and the current PGTK to the non-AP MLD. More precisely, for MLO, with RSN and a valid PTK is configured for the non-AP MLD, If management frame protection is negotiated for the MLDs, the current GTK, IGTK when management frame protection is negotiated, and BIGTK when beacon protection is negotiated for each setup link, PMGTK when BPE is supported shall be included in the WNM Sleep Mode Response frame using the WNM Sleep Mode MLO GTK/IGTK/BIGTK/PMGTK subelement. If a GTK/IGTK/BIGTK/PMGTK update is in progress for one or more links, the pending GTK, IGTK when management frame protection is negotiated, and BIGTK when beacon protection is negotiated for each of the affected AP(s), PMGTK when BPE is supported shall be included in the WNM Sleep Mode Response frame using the WNM Sleep Mode MLO GTK/IGTK/BIGTK/PMGTK subelement. A non-AP MLD identifies the corresponding link to which the GTK/IGTK/BIGTK/PMGTK belongs based on the value of the Link ID subfield included in the subelement of the Key Data field.

A sub-element is identified by an Optional sub-element ID, as specified in Table 9-540 of the Optional sub-element IDs for WNM Sleep Mode parameters of the IEEE P802.11REVme™/D7.0 standard. A specific value that was reserved until now may be assigned to MLO PMGTK sub-element, like the value 7, as illustrated in FIG. 10.

FIG. 11 illustrates an example of a WNM Sleep Mode MLO PMGTK sub-element format. The MLO PGTK sub-element contains a Subelement ID field, a length field, a Link ID Info field, a Key ID field, a PMPN field, a Link ID Info field, a PMPN field and a Key field.

The Subelement ID field is set to the value of the Optional subelement ID assigned to a MLO PMGTK, for example the value 7. It may be specified in a table like Table 9-540 in the IEEE P802.11REVme™/D7.0 standard, as illustrated in FIG. 10. The Length field is defined in the section 9.4.3 (Subelements) of the IEEE P802.11REVme™/D7.0 standard. The Key ID field contains the PMGTK key ID. The PMPN field contains the current RSC for the PMGTK being installed. The RSC for an PMGTK is the PMGTK packet number (PMPN). The Key field is the PMGTK being distributed for the BPE AP operating on the link identified by the Link ID sub field.

When the non-AP MLD receives the WNM Sleep Mode Response frame from the AP MLD via one of its affiliated non-AP STAs, all the affiliated non-AP STAs of the non-AP MLD should delete the GTKSA if the response indicates success. If a RSN is used with a management frame protection, the non-AP STA should delete the IGTKSA if the response indicates success. If RSN is used with beacon frame protection, the non-AP STA shall delete the BIGTKSA if the response indicates success. If BPE is supported, the non-AP STA shall delete the PMGTKSA if the response indicates success. If EDP epoch is supported by both the AP MLD and the non-AP MLD, the non-AP MLD shall delete the PGTKSA if the response indicates success.

### Hardware for Carrying Out the Steps of Some Embodiments of the Disclosure

FIG. 13 schematically illustrates an example of a communication device that may correspond any of the stations described by reference to FIG. 1, of a wireless network, configured to implement at least some embodiments of the disclosure. The communication device, referenced 1300, may preferably be a device such as a micro-computer, a workstation, or a light portable device. Communication device 1300 may comprise a communication bus 1305 to which may be connected:
a central processing unit 1301, such as a processor, denoted CPU;
a memory 1303, denoted MEM, for storing an executable code of methods or steps of the methods according to embodiments of the disclosure as well as the registers adapted to record variables and parameters necessary for implementing the methods; and
at least two communication interfaces 1302 and 1302′ connected to the wireless communication network, for example a communication network according to one of the IEEE 802.11 family of standards, via transmitting and receiving antennas 1304 and 1304′, respectively.

Preferably, communication bus 1305 may provide communication and interoperability between the various elements included in the communication device 1300 or connected to it. The representation of the bus is not limiting and in particular the central processing unit is operable to communicate instructions to any element of the communication device 1300 directly or by means of another element of the communication device 1300.

The executable code may be stored in a memory that may either be read only, a hard disk, or on a removable digital medium such as for example a disk. According to an optional variant, the executable code of the programs can be received by means of the communication network, via the interface 1302 or 1302′, in order to be stored in the memory 1303 of communication device 1300 before being executed.

In some embodiments, communication device 1300 may be a programmable apparatus which uses software to implement embodiments of the disclosure. However, alternatively, some embodiments of the disclosure may be implemented, totally or in partially, in hardware (for example, in the form of an Application Specific Integrated Circuit or ASIC).

At least some of the embodiments of the disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard-disk, a random-access memory (RAM), a read-only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the disclosure.

1. A method in a communication network, the method comprising, at an access point, AP, affiliated with an AP multi-link device, MLD:
transmitting, to a non-AP station, STA, affiliated with a non-AP MLD, a management frame comprising a body field encrypted with a first group key; and
transmitting, to the STA, a frame including the first group key and a second group key, wherein the second group key is for encrypting data frames transmitted by the AP to the STA.

2. The method of claim 1, wherein the management frame is a beacon frame.

3. The method of claim 2, wherein the beacon frame is a privacy beacon frame.

4. The method of claim 3, wherein the body field comprises a Basic Service Set, BSS, Parameter Change Count, BPCC, a Traffic Indication Map, TIM, a Reduced Neighbor Report, and/or an Extended Channel.

5. The method of claim 1, wherein the first group key is generated by the non-AP MLD and shared among all APs affiliated with the non-AP MLD.

6. The method of claim 1, wherein several APs, comprising the AP, are affiliated with the non-AP MLD, each of the several APs generating its own first group key, all the generated first group keys being transmitted to the STA in the frame including the first group key and a second group key in a MLO element.

7. The method of claim 1, wherein a same cipher suite is used in relation to the first and the second group key to encrypt the data frame and the body field of the management frame.

8. The method of claim 1, wherein the first group key and the second group key are transmitted in a Key Delivery element included in a (Re) Association Response frame during an association procedure.

9. The method of claim 1, wherein the first group key and the second group key are updated and transmitted during a group key handshake.

10. The method of claim 9, wherein the group key handshake is carried out upon determining sleep mode exit of the non-AP MLD.

11. The method of claim 1, further comprising creating a privacy security association in a robust security network association, RSNA, between the AP MLD and the STA, the first group key and the second group key being stored in the AP MLD, in the privacy security association.

12. The method of claim 11, wherein the privacy security association is created upon determining a successful group key handshake, reassociation response frame of a fast basic service set, BSS, transition protocol, or successful fast initial link setup, FILS, or authentication.

13. The method of claim 11, further comprising deleting the privacy security association storing the first group key and the second group key upon determining that the AP MLD is in an independent basic service set, IBSS, or upon determining an association, reassociation or dissociation procedure of the non-AP MLD.

14. The method of claim 1, wherein the first group key and the second group key are transmitted to the STA as wrapped keys with key identifiers in a frame subelement.

15. The method of claim 1, wherein the first group key is a privacy management group temporal key, PMGTK, which value is a random number.

16. The method of claim 1, further comprising deleting the first group key upon determining dissociation of the STA.

17. A method in a communication network, the method comprising, at a non access-point, AP, station, STA, affiliated with a non-AP multi-link device, MLD:
receiving, from an AP affiliated with an AP MLD, a management frame comprising a body field encrypted with a first group key; and
receiving, from the AP, a frame including the first group key and a second group key, wherein the second group key is for decrypting data frames received from the AP.

18. The method of claim 17, wherein the management frame is a beacon frame.

19. The method of claim 18, wherein the beacon frame is a privacy beacon frame.

20. The method of claim 19, further comprising associating or reassociating the STA with the AP using elements of the body field of the beacon frame.

21. The method of claim 17, wherein the first group key and the second group key are obtained in a Key Delivery element included in a (Re) Association Response frame during an association procedure mechanism.

22. The method of claim 17, wherein the first group key and the second group key are updated during a group key handshake.

23. The method of claim 17, further comprising creating a privacy security association in a robust security network association, RSNA, between the AP MLD and the non-AP MLD, the first group key and the second group key being stored in the non-AP MLD, in the privacy security association.

24. The method of claim 23, further comprising deleting the privacy security association storing the first group key and the second group key upon determining an association, reassociation, or dissociation procedure of the non-AP MLD.

25. The method of claim 17, wherein the first group key and the second group key are received as wrapped keys with key identifiers in a frame subelement.

26. A non-transitory computer-readable storage medium storing instructions of a computer program for implementing each of the steps of the method according to claim 1.

27. A communication device comprising a processing unit configured for carrying out each of the steps of the method according to claim 1.

28. A non-transitory computer-readable storage medium storing instructions of a computer program for implementing each of the steps of the method according to claim 17.

29. A communication device comprising a processing unit configured for carrying out each of the steps of the method according to claim 17.
